(19) United States
(12) Patent Application Publication
(10) Pub. No.: US 2012/0238656 A1
(43) Pub. Date: Sep. 20, 2012

(54) PROCESS FOR THE PREPARATION OF FLEXIBLE POLYURETHANE AND FOAM OBTAINED THEREBY

(75) Inventor: Jean-Pierre De Kesel, Putte-Peulis (BE)

(73) Assignee: RECTICEL, Brussels (BE)

(21) Appl. No.: 13/394,511

(22) PCT Filed: Dec. 3, 2010
(86) PCT No.: PCT/EP10/68894

§ 371 Date: May 17, 2012

(30) Foreign Application Priority Data
Dec. 8, 2009 (EP) 09178404.1

(51) Int. Cl. C08L 75/04

(52) U.S. Cl. 521/137

(57) ABSTRACT

The present invention is directed to a process for the preparation of a flexible polyurethane foam and to the polyurethane foam prepared by that process. The foam is in particular a flexible polyurethane foam which has a density of between 25 and 120 kg/m³, a resilience, measured at 20° C. in accordance with ASTM D 3574 H, higher than 35%, and an ILD 40% hardness, measured in accordance with ISO 2439 B, of between 60 and 500 N. It is prepared by allowing a reaction mixture, which comprises a blowing agent, to foam. In order to influence the physical and/or thermophysiological properties of the foam, in particular the pressure distribution properties, at least one organogel material is dispersed in the reaction mixture before allowing it to foam.

The present invention is directed to a process for the preparation of a flexible polyurethane foam and to the polyurethane foam prepared by that process. The foam is in particular a flexible polyurethane foam which has a density of between 25 and 120 kg/m³, a resilience, measured at 20° C. in accordance with ASTM D 3574 H, higher than 35%, and an ILD 40% hardness, measured in accordance with ISO 2439 B, of between 60 and 500 N.

Flexible polyurethane foams are widely used for body support applications, such as mattresses, mattress toppers, pillows, cushions of any types for use in beds, seats or other applications such as floor mats, etc. Besides providing functional support to the human body, the body supporting material should also provide a good pressure distribution, a sufficient physiological comfort, as well as an adequate breathability.

High resilience (HR) polyurethane foams have been widely used for body support applications, due to their superior support and resilience characteristics. They have in particular a quite high SAG factor and also a high resilience. However, the uniformity of the pressure distribution on such kind of foams is not optimal, which may lead to pressure-points, and making them thus not suitable for people requiring pressure-relief, for instance in hospitals where long-term patients often suffer from pressure sores.

Visco-elastic (VE) foams have found wide acceptance as body support materials. In contrast to conventional polyurethane foams and high resilience polyurethane foam they have resilience figures which are markedly lower than 40%, and which are usually even lower than 15%. VE foams are rather soft but supportive foam materials, characterised by a very slow recovery and an indentation hardness which is temperature sensitive. This property allows the body to sink more deeply into the foam, while still maintaining the firm feel of a good quality resilient foam. VE foams thus gently conform to the shape of the user's body, allowing pressure to be absorbed uniformly and distributed more evenly, which is of particular benefit in the prevention and healing of pressure sores. A disadvantage of VE foams is however that their hardness increases with decreasing temperature, which makes them very uncomfortable for use in cold rooms or areas. Further, VE foams are denser and more closed-celled than conventional HR foams, leading to a worse breathability and thus decreased thermophysiological comfort.

Another class of materials used for body support materials are gels. Gels are very well-known for their excellent balanced pressure distribution, due to their three dimensional deformation properties leading to flattening pressure points. They further provide a good physical comfort, such as a low hardness and a good elasticity, and provide the user with a good “feel”. However, gels, such as polyurethane gels, exhibit a relatively high thermal conductivity as well as a very high heat capacity. This leads to a cool feel as heat is removed from the body when in contact with the gel. A further disadvantage of gels is that they have a very high dead weight (specific weight usually between 600-1100 kg/m³). In order to decrease the specific weight of gels, cellular gels, such as cellular polyurethane gels, have been developed, as disclosed in U.S. Pat. No. 4,404,296. They are blown with an inert gas such as air, N₂ or CO₂. Besides the reduced specific weight, their heat capacity is reduced as well. However, cellular gels have the disadvantage that under influence of compression, the cells of the foamed gel stick to each other because of the undercrosslinked matrix, and that the foamed gel has bad mechanical properties, especially a very bad elasticity. Besides their very low resiliency, they are not breathable at all since they don't allow any air transfer. Foamed gels are thus not at all suitable as body support materials.

Because of their very high specific weight and their high thermal capacity, gel layers are preferably used with one or more additional body supporting layers, such as foam layers, spring layers and the like. Mattress or mattress toppers comprising polyurethane gel layers overlying foam layers are for instance known from WO 2006/100558, US 2001/0018466 and US 2005/0017396. Gel layers may be integrally attached to the additional support layers, for instance by gluing, sewing, welding or by chemical bonding. Gel layers can also be separate bodies inserted in foam layers, as illustrated in US2007/0226911. In order to enable the gel layers to develop their pressure distributing effect, they need a complete envelopment by means of a relatively thin highly elastic cover, which should be impermeable to prevent penetration of the tacky gel material through the cover. Such cover is disadvantageous for air passage and thus breathability. Furthermore, it increases the production cost of the body support manufacturing process. Due to the minimum thickness required to achieve the desired pressure distribution properties, the obtained mattresses with integrated gel layers are still very heavy and thus difficult to handle.

In order to lower the weight, the overall rate of thermal transfer and the overall thermal mass of a gel mattress which consists of a gel layer covered with an upper and a lower foam layer, US 2005/0017396 discloses an extruded gel layer which has vertical hollow columns. These hollow columns have walls which partially or completely buckle when a person is lying on the mattress. A drawback of this mattress is that its weight is still substantially larger than the weight of a polyurethane foam mattress. The gel layer has indeed to be relatively thick in order to provide the desired improved pressure distribution effects. Moreover, due to the vertical hollow columns in the gel layer, these pressure distribution properties are lost to some extent and, what's more, the load bearing properties of the mattress are getting worse. In this respect the SAG factor is an important parameter of a body supporting foam. This SAG factor or support factor is the compressive strength at 65% indentation divided by the compressive strength at 25% indentation. A good support and a comfortable feeling is provided by foams such as HR foams and latex foams which have a relatively high SAG factor, more particularly a SAG factor higher than 2.5. A drawback of the hollow columns in the gel layer is that when the walls thereof buckle under the load of a person lying on the mattress, the compressive strength provided by these walls is reduced so that the person is not or less optimally supported.

It is an object of the invention to provide a new process for preparing a flexible polyurethane foam which is resilient and breathable but which still enables to provide improved foam properties without showing however the drawbacks of a gel layer.

To this end, the process for the preparation of a flexible polyurethane foam according to the present invention, comprises the step of allowing a reaction mixture, which comprises a blowing agent, to foam to produce the polyurethane foam, and is characterised in that before the reaction mixture is allowed to foam, at least one organogel material is dispersed therein. The organogel material is thus incorporated in the polyurethane foam upon foam expansion to form at least part of the cell ribs and/or cell walls of this polyurethane foam.

Incorporating a gel material in a polyurethane coating material is already known per se from WO 01/32791. The polyurethane coating material is not a flexible polyurethane foam but is a rigid foam or a microcellular elastomer and has a density which is generally higher than 200 kg/m³. The gel material is incorporated in this polyurethane coating material to improve the insulating properties thereof. In contrast to the present invention, the gel material is therefore an aerogel or xerogel, which contains no liquid and which is thus a solid material.

The organogel material used in the process of the present invention is on the contrary a dimensionally stable, jelly-like material. Gels are defined as a substantially dilute cross-linked system which exhibits no flow when in the steady state. Gels are mostly liquid, yet they behave like solids due to the three-dimensional crosslinked network within the liquid. Apart from the xerogels, which are dried to form a porous product which is not jelly-like anymore, there are two main types of gels namely hydrogels and organogels. Hydrogels contain water as the dispersion medium (liquid). Organogels are composed of a liquid organic phase entrapped in a three-dimensionally cross-linked network. They are highly elastic. In the flexible polyurethane foam according to the invention, the organogel material forms part of the cell ribs and/or cell walls so that the physical properties of the foam are modified thereby. The incorporation of the organogel material in the polyurethane material of the foam may in particular reduce the tensile stress in the foam material when locally compressing this material. In this way, a better pressure distribution can be achieved without the drawbacks of a gel layer and while maintaining the desired support and resilient properties of the polyurethane foam. Such advantageous effect cannot be achieved when simply coating the cell ribs and/or the cell walls of a polyurethane foam with an organogel material, for example by impregnation the foam therewith.

In a preferred embodiment of the process according to the invention, the organogel material is dispersed in the reaction mixture in an amount of at least 0.1 wt. %, preferably at least 1 wt. %, more preferably at least 5 wt. % and most preferably at least 10 wt. %, calculated on the total weight of the polyurethane foam prepared from the reaction mixture.

In a further preferred embodiment of the process according to the invention, the organogel material is dispersed in the reaction mixture in an amount of less than 40 wt. %, preferably less than 30 wt. % and more preferably less than 20 wt. %, calculated on the total weight of the polyurethane foam prepared from the reaction mixture.

Advantageously, the organogel is a gel selected from the group consisting of polyurethane gels, oil extended thermoplastic block copolymer gels, in particular SEBS gels, silicone gels and PVC plastisol gels, the organogel material being preferably a polyurethane gel.

In a particular embodiment, which is especially suited for body support applications, the flexible polyurethane foam obtained by the process according to the invention has a density of between 25 and 120 kg/m³, a resilience, measured at 20° C. in accordance with ASTM D 3574 H, higher than 35%, and an ILD 40% hardness, measured in accordance with ISO 2439 B, between 60 and 500 N.

To provide good support properties, the SAG factor of the foam is preferably greater than 1.8, more preferably greater than 2.0 and most preferably greater than 2.2.

The invention also relates to the flexible polyurethane foam obtained by the process according to the invention. This foam may comprise cell ribs and cell walls, the organogel material being incorporated in the foam to form at least part of these cell ribs and/or cell walls, or the foam may comprise substantially only cell ribs (being in particular a reticulated foam), the organogel material being incorporated in the foam to form at least part of these cell ribs. In a preferred embodiment, the organogel material forms gel inclusions in the cell ribs and/or cell walls. The physical properties of the foam are thus changed by the presence of the organogel inclusions in the cell ribs and/or in the cell walls.

Other particularities and advantages of the invention will become apparent from the following description of some particular embodiments of the process for preparing a flexible polyurethane foam according to the present invention.

The invention is directed to a process for the preparation of a flexible polyurethane foam. The term polyurethane foam embraces not only pure polyurethane foam but also polyurea modified polyurethane foams. The term “flexible” indicates a foam which has an ILD 40% hardness of less than 500 N and thus embraces also soft or hypersoft foams. The flexible polyurethane foam can be intended for several applications but is especially intended for seating and bedding applications. It has preferably an ILD 40% hardness, measured in accordance with ISO 2439 B, between 60 and 500 N, and more preferably between 90 and 200 N. The resilience or ball rebound of the foam, measured at 20° C. in accordance with ASTM D 3574 H, is preferably higher than 35% and more preferably higher than 45%. The density of the foam is preferably between 25 and 120 kg/m³ and is more preferably lower than 100 kg/m′ and most preferably lower than 80 kg/m′. The foam is preferably an open cell foam.

The flexible polyurethane foam is prepared by allowing a reaction mixture, which comprises a blowing agent, to foam. The blowing agent preferably comprises water which reacts with isocyanate groups to produce carbon dioxide gas. The known one-shot, semi-prepolymer or full prepolymer techniques may be used together with conventional mixing equipment and the foams may be produced in the form of slabstock, mouldings and the like. In the full prepolymer techniques, the reaction mixture is prepared by mixing an isocyanate prepolymer with an aqueous mixture (comprising a surfactant) to produce the polyurethane foam. This technique is used in particular for preparing hydrophilic polyurethane foam. For producing flexible polyurethane foam for seating and bedding applications, the one-shot or the semi-prepolymer techniques are usually applied. In these techniques a polyurethane reaction mixture is composed by mixing at least an isocyanate component and an isocyanate reactive component. In the semi-prepolymer techniques, the isocyanate component comprises an isocyanate prepolymer and/or the isocyanate reactive component comprises an isocyanate reactive prepolymer, in particular a polyol prepolymer.

An essential feature of the process according to the invention is that before the reaction mixture is allowed to foam, at least one organogel material is dispersed therein. The organogel material is in other words distributed substantially evenly throughout the liquid reaction mixture. The organogel can be dispersed in the reaction mixture by adding it separately to that reaction mixture. When the reaction mixture is composed by mixing at least an isocyanate component and an isocyanate reactive component, it can be dispersed in one or both of these components, preferably in the isocyanate reactive component.

The organogel is a dimensionally stable, jelly-like material. It consists mainly of a liquid but it behaves like a solid due to the presence of a three-dimensional crosslinked network within the liquid. The liquid in an organogel is an organic liquid whilst the liquid in a hydrogel is water. An important drawback of hydrogels is that they easily dry out because of the evaporation of water, which leads to hardening of hydrogels. In the process according to the invention this cannot be prevented by encasing the gel material in an elastic film since the gel material is to be dispersed in the reaction mixture. Hydrogels are further disadvanteous in the process according to the invention, because the big amount of water entrapped in the hydrogel, might interfere with the polyurethane foam forming reaction, which is undesired. Consequently, use is made in the process according to the present invention of organogels which contain an organic liquid. This organic liquid is less volatile than water and/or is bonded in the gel so that it will not or substantially not evaporate from the gel material. The gel is preferably an anhydrous gel which contains substantially no water.

One physical property of the gel is the gel strength or gel rigidity. The gel rigidity, expressed in gram Bloom, is determined by the gram weight required to depress a gel a distance of 4 mm with a circular piston having a cross-sectional area of 1 square centimetre at 23° C. It can be determined in accordance with the British Standard BS 757 (1975). The organogel used in the process of the present invention has preferably a gel rigidity of at least 5 grams, more preferably of at least 10 grams and most preferably of at least 20 grams. Such gel rigidities are high enough to support a three-dimensional gel configuration, which is not the case for pre-polymers which may also be contained as explained hereabove in the reaction mixture and which may be quite viscous but which don't show any gel rigidity at all. The organogel has preferably a gel rigidity which is smaller than 700 grams, more preferably smaller than 500 grams and most preferably smaller than 350 grams.

The organogel material may be of different compositions. It may comprise for example a silicone gel, in particular an organosiloxane gel. Suitable examples of such a gel are described in U.S. Pat. No. 4,072,635, which is incorporated herein by way of reference. The organogel material may also comprise a PVC plastisol gel. Examples of such a gel are described in U.S. Pat. No. 5,330,249, which is incorporated herein by way of reference. Oil extended thermoplastic block copolymer gels are also suitable gels. Examples of these oil gels, more particularly of SEBS gels (poly(styrene-ethylene-butylene-styrene) gels), are described in U.S. Pat. No. 5,508,334 and U.S. Pat. No. 5,336,708, which are incorporated herein by way of reference. These oil gels contain high levels of a plasticizing oil to achieve the gelatinous properties.

The organogel material used in the process of the present invention preferably comprises a polyurethane gel. Examples of such polyurethane gels are described in U.S. Pat. No. 4,404,296, U.S. Pat. No. 4,456,642 and in U.S. Pat. No. 5,362,834, which are incorporated herein by way of reference.

Polyurethane gels, are materials of gel-like consistency, which contain one or more polyols within a certain molecular weight range as the coherent dispersing agent in which a polymeric network which is covalently linked via urethane bonds, is dispersed. They can for instance be obtained by reacting one or more higher-functional higher-molecular weight polyols with a quantity of an organic di- or polyisocyanate in the presence of appropriate polyurethane forming catalysts, provided that an isocyanate index between 15-60 is applied and provided that the isocyanate component or polyol component has a certain minimum functionality and that the polyol is essentially free of any polyol having an OH number greater than 112 or a molecular weight below 800. The anhydrous polyurethane gels prepared in this way consist of a high-molecular weight covalently crosslinked polyurethane matrix, dispersed in a liquid dispersing agent (polyol) firmly bonded in the matrix.

The liquid dispersing agent is a polyhydroxy (poylol) compound having a molecular weight between 1000 and 12000 and an OH number between 20 and 112, and is free of hydroxy compounds having a molecular weight below 800. The advantage of these polyurethane gels is that their consistency can be varied between a jelly-like or gelatine state and a solid jelly by varying the isocyanate index and the functionality of the starting materials, and that they have an exceptional stability, even at high temperatures, due to the fact that the polyol dispersing agent is firmly bonded in the gel. The preparation of the gels can be obtained by the so-called one-shot process or by a prepolymer process, as is clearly disclosed in U.S. Pat. No. 4,456,642. The obtained gels can be used in a wide variety of forms, such as granulates, foils, molded articles. A gel granulate is particularly preferred when the gel is to be admixed to a polyurethane forming composition.

Up to 50% of an active ingredient may be included in the gel-forming composition. Active ingredients refer to any additive capable of providing a benefit to a user, such as for instance biocides, fragrances, anti-allergic agents, fungicides, phase change materials (PCM). They are preferably mixed or dispersed in the polyol component before the other reactants are combined with the polyol. Organogels containing active ingredients have the advantage over the known polyurethane foams, that the outward migration of even solid or low volatile active ingredients, remains active over a long time period. Other filler types can be added as well to the gel, such as powders, nanoparticles, microspheres of synthetic or natural materials.

The organogel is preferably dispersed in the reaction mixture in an amount of at least 0.1 wt. %, preferably at least 1 wt. %, more preferably at least 5 wt. % and most preferably at least 10 wt. %. The amount of organogel dispersed in the reaction mixture is preferably smaller than 40 wt. %, more preferably smaller than 30 wt. % and most preferably smaller than 20 wt. %. These percentages are calculated on the total weight of the polyurethane foam prepared from the reaction mixture.

The organogel is preferably dispersed in the reaction mixture in the form of particles having an average volume of between 0.001 and 10 mm³, which average volume is preferably larger than 0.01 mm³, more preferably larger than 0.1 mm³, and preferably smaller than 2 mm³, more preferably smaller than 0.5 mm³. Such particle size can be achieved by adding the organogel in a particulate form, more particularly in a granular of powder form or it can be achieved by adding larger pieces of gel material and by homogenizing these pieces of gel material. This can be done in the reaction mixture itself and/or in one or more of the components which are mixed with one another to compose the reaction mixture.

Due to the fact that the organogel material is dispersed in the reaction mixture, and does not dissolve entirely therein, the dispersed particles of the organogel are incorporated in the flexible polyurethane foam during foam expansion, more particularly in the cell ribs and/or cell walls thereof. The organogel forms inclusions in these cell ribs and/or cell walls. At the interface between the polyurethane material and the organogel material, some of the reaction components of the polyurethane material may have penetrated somewhat into the organogel material, which may provide for an increased adhesion between both materials. When the organogel material comprises reactive groups which may react with one or more of the reaction components of the polyurethane material, a chemical bond can also be achieved between both materials, leading to a strong immobilisation of the PU gel in the PU foam.

The presence of the organogel inclusions in the cell ribs and/or cell walls of the polyurethane foam influences the physical and/or thermophysiological properties of the foam. They may for example reduce the tensile stresses in the foam thus improving the pressure distribution properties. On the other hand, they can give the foam also a softer, gel-like feel and thus improve the comfort feeling of the foam. They may also have an effect on the heat capacity of the foam and even on the thermal conductivity, thus giving the foam a cooler feel. Since the gel particles will also have some effect on the foam formation, they may also increase the open cell content of the foam.

The presence of inclusions of another material in the polyurethane material of the flexible foam, may also reduce some physical foam properties such as the wet compression set. It has however been found that the wet compression set of the foam can be improved by the use of a polyol having a high oxyethylene unit content.

As explained already hereabove, the reaction mixture is preferably composed by mixing at least an isocyanate component and an isocyanate reactive component. The organogel can be dispersed in the reaction mixture itself, in the isocyanate component and/or in the isocyanate reactive component.

The polyisocyanate component comprises usually only one but may comprise more than one polyisocyanate compounds (=polyisocyanates). Organic polyisocyanates which are conventionally used in the preparation of flexible polyurethane foams include aliphatic, cycloaliphatic and araliphatic polyisocyanates, as well as aromatic polyisocyanates, such as the commercial TDI (toluene diisocyanate), MDI (diphenylmethane diisocyanate), and crude or polymeric MDI.

Polymeric MDI may contain at least 70% by weight of pure MDI (4,4′-isomer or isomer mixture) and up to 30% by weight of the so-called polymeric MDI containing from 25 to 65% by weight of diisocyanates, the remainder being largely polymethylene polyphenylene polyisocyanates having isocyanate functionalities greater than 2. Mixtures may also be used of pure MDI and polymeric MDI compositions containing higher proportions (up to 100%) of the said higher functionality polyisocyanates.

Modified isocyanates are also useful. Such isocyanates are generally prepared through the reaction of a commercial isocyanate, for example TDI or MDI, with a low molecular weight diol or amine. Modified isocyanates can also be prepared through the reaction of the isocyanates with themselves, producing isocyanates containing allophanate, uretonimine, carbodiimide or isocyanurate linkages. Modified forms of MDI including polyurea dispersions in MDI have for instance been described in EP-A-0 103 996.

The isocyanate reactive component may comprise moreover one or more solid polymers, which are no organogels, stably dispersed in this component. The production of stably dispersed polymers within polyols to make polymer polyols is known in the art. The basic patents in the field are U.S. Pat. No. 3,383,351 and U.S. Pat. No. 3,304,273. Such compositions can be produced by polymerizing one or more ethylenically unsaturated monomers dissolved or dispersed in a polyol in the presence of a free radical catalyst to form a stable dispersion of polymer particles in the polyol. These polymer polyol compositions have the valuable property of imparting to polyurethane foams produced therefrom higher load-bearing properties than are provided by the corresponding unmodified polyols. Also included are the polyols like those taught in U.S. Pat. No. 3,325,421 and U.S. Pat. No. 4,374,209.

A wide variety of monomers may be utilized in the preparation of the polymer polyol. Numerous ethylenically unsaturated monomers are disclosed in the prior patents and polyurea and polyurethane suspension polymers can also been utilized. Exemplary monomers include styrene and its derivatives such as para-methylstyrene, acrylates, methacrylates such as methyl methacrylate, acrylonitrile and other nitrile derivatives such as methacrylonitrile, and the like. Vinylidene chloride may also be employed. The preferred monomer mixtures used to make the polymer polyol are mixtures of acrylonitrile and styrene (SAN polyols) or acrylonitrile, styrene and vinylidene chloride.

In order to avoid the negative influence of the organogel particles and of the solid polymer particles on the wet compression set of the foam, the isocyanate reactive component comprises preferably isocyanate reactive compounds which include, per 100 parts by weight thereof (not including the water and any organogel or any solid polymer dispersed therein):

a) 50 to 80 parts of one or more polyoxyalkylene polyols having an oxyethylene unit content of at least 40 wt. % of the oxyalkylene units of the polyoxyalkylene polyol, a hydroxyl number of between 20 and 100, preferably of between 20 and 60, and a nominal functionality of 2 to 4; and
b) 20 to 50 parts of one or more further polyoxyalkylene polyols containing no oxyethylene units or having an oxyethylene unit content lower than 40 wt. % of the oxyalkylene units of the further polyoxyalkylene polyol, and having a hydroxyl number of between 20 and 100, preferably of between 20 and 60, and a nominal functionality of 2 to 4.

The term “nominal functionality” is used herein to indicate the functionality (number of hydroxyl groups per molecule) of the polyol on the assumption that the functionality of the polyoxyalkylene polyol is equal to the functionality (=number of active hydrogen atoms per molecule) of the initiator used in its preparation, although in practice it will often be somewhat less because of some terminal unsaturation. When two or more initiators are used so that a mixture of polyoxyalkylene polyols is obtained, each of the different polyols of this mixture is to be considered as a separate polyol (isocyanate reactive compound). The initiator may be for example glycerine, trimethylolpropane or diethylene triamine.

The parts and percentages mentioned in the present specification are all by weight.

The term “hydroxyl number” indicates the number of milligrams KOH which are equivalent to one gram of polyol sample so that the equivalent weight of the polyol=56100/hydroxyl number.

The polyoxyalkylene polyols of type a which have an oxyethylene unit content of at least 40 wt. %, i.e. the EO rich polyol or polyols, are preferably used in an amount of at least 55 parts, more preferably in an amount of at least 60 parts, and most preferably in an amount of at least 65 parts per 100 parts of the isocyanate reactive groups containing compounds. Preferably, they are used in an amount of less than 75 parts per 100 parts of the isocyanate reactive groups containing compounds in view of the better mechanical properties which can be achieved and also in view of maintaining a good processability.

The high amount of the EO rich polyol or polyols, also increases the open cell content of the foam. An advantage of an open cell foam is that it does not shrink after its production, and does not require a separate crushing or reticulation step, as is usually required with the conventional HR polyurethane foams. The EO rich polyol or polyols preferably have an oxyethylene unit content of at least 50 wt. %, more preferably of at least 60 wt. % and most preferably of at least 70 wt. %, of the oxyalkylene units of the polyoxyalkylene polyol. Advantagously, the EO rich polyol or polyols have an oxyethylene unit content of less than 90 wt. %, preferably of less than 85 wt. % and more preferably of less than 80 wt. %, of the oxyalkylene units of the polyoxyalkylene polyol.

In addition to the oxyethylene units, the oxyalkylene chains usually comprise oxypropylene units. A portion of the ethylene oxide (in particular less than 25% of the oxylkylene units) may be used for end capping the oxyalkylene chains so that the polyol has a higher primary hydroxyl content, for example a primary OH content higher than 50%. In this way, the polyol is more reactive towards the isocyanates. The remaining part of the oxyethylene units should be distributed over the oxyalkylene chain and this preferably randomly.

The isocyanate reactive compounds may contain, in addition to the EO rich polyol or polyols of type a and the further polyol or polyols of type b (which have a lower EO content), other compounds which have a relatively large equivalent weight, more particularly an equivalent weight higher than 561 (=56100/100). These compounds include for example polyesters containing primary or secondary hydroxyl groups or also polyamines. However, the isocyanate reactive compounds preferably comprise, per 100 parts, at least 85 parts, more preferably at least 95 parts, of the EO rich polyol or polyols of type a and of the further polyol or polyols of type b (which are polyether polyols).

By the process according to the invention, foams can be produced having a tear resistance, measured in accordance with ASTM D3574 F, higher than 1 N/cm, an elongation, measured in accordance with EN ISO 1798, higher than 100%, and a tensile strength, measured in accordance with EN ISO 1798 , higher than 50 kPa, preferably higher than 70 kPa.

The preferred foaming agent for use in the process of the invention is water, optionally in conjunction with a physical blowing agent, for example a low boiling organofluoro compound. As is known to the skilled person, the amount of foaming agent may be varied in order to achieve the desired foam density. Preferably water is the only foaming agent. The isocyanate index (NCO index) of the reaction system may vary between 80 and 120, but is preferably higher than 90 and more preferably higher than 100. A higher isocyanate index can assist in achieving a higher foam hardness.

The foam formulation may contain one or more of the additives conventional to polyurethane foam formulations. Such additives include catalysts, for example tertiary amines and tin compounds, surface-active agents and foam stabilisers, for example siloxane-oxyalkylene copolymers, flame retardants, organic and inorganic fillers, pigments, agents for suppressing the so-called boiling-foam effect such as poly-dimethyl siloxanes, and internal mould release agents for moulding applications.

1. A process for the preparation of a flexible polyurethane foam wherein a reaction mixture, which comprises a blowing agent, is allowed to foam to produce the polyurethane foam, characterised in that before allowing said reaction mixture to foam, at least one organogel material is dispersed therein.

2. A process according to claim 1, characterised in that said organogel material is dispersed in the reaction mixture in an amount of at least 0.1 wt. %, preferably at least 1 wt. %, more preferably at least 5 wt. % and most preferably at least 10 wt. %, calculated on the total weight of the polyurethane foam prepared from the reaction mixture.

3. A process according to claim 1, characterised in that said organogel material is dispersed in the reaction mixture in an amount of less than 40 wt. %, preferably less than 30 wt. % and more preferably less than 20 wt. %, calculated on the total weight of the polyurethane foam prepared from the reaction mixture.

4. A process according to claim 1, characterised in that said organogel material is a gel selected from the group consisting of polyurethane gels, oil extended thermoplastic block copolymer gels, in particular SEBS gels, silicone gels and PVC plastisol gels, and the organogel material being preferably a polyurethane gel.

5. A process according to claim 1, characterised in that said organogel material is dispersed in said reaction mixture in the form of particles having an average volume of between 0.001 and 10 mm³, which average volume is preferably larger than 0.01 mm³, more preferably larger than 0.1 mm³, and preferably smaller than 2 mm³, more preferably smaller than 0.5 mm³.

6. A process according to claim 1, characterised in that said reaction mixture is a polyurethane reaction mixture composed by mixing at least an isocyanate component and an isocyanate reactive component, at least a portion of said organogel material being dispersed in said isocyanate reactive component before mixing it with the isocyanate component.

7. A process according to claim 1, characterised in that said reaction mixture is a polyurethane reaction mixture composed by mixing at least an isocyanate component and an isocyanate reactive component, the isocyanate reactive component comprising isocyanate reactive compounds including, per 100 parts by weight thereof,
a) 50 to 80 parts of one or more polyoxyalkylene polyols having an oxyethylene unit content of at least 40 wt. % preferably of at least 50 wt. %, more preferably of at least 60 wt. % and most preferably of at least 70 wt. %, of the oxyalkylene units of the polyoxyalkylene polyol, a hydroxyl number of between 20 and 100, preferably of between 20 and 60, and a nominal functionality of 2 to 4, the oxyethylene unit content being preferably smaller than 90 wt. %, preferably smaller than 85 wt. % and more preferably smaller than 80 wt. %, of the oxyalkylene units of the polyoxyalkylene polyol; and
b) 20 to 50 parts of one or more further polyoxyalkylene polyols containing no oxyethylene units or having an oxyethylene unit content lower than 40 wt. % of the oxyalkylene units of the further polyoxyalkylene polyol, and having a hydroxyl number of between 20 and 100, preferably of between 20 and 60, and a nominal functionality of 2 to 4,
the isocyanate reactive compounds comprising, per 100 parts by weight thereof, preferably at least 85 parts, and more preferably at least 95 parts, of said one or more polyoxyalkylene polyols and said one or more further polyoxyalkylene polyols.

8. A process according to claim 7, characterised in that the isocyanate reactive compounds comprise, per 100 parts by weight thereof, at least 55 parts, preferably at least 60 parts, more preferably at least 65 parts of said one or more polyoxyalkylene polyols which have an oxyethylene unit content of at least 40 wt. %.

9. A process as claimed in claim 7, characterised in that the isocyanate reactive compounds comprise, per 100 parts by weight thereof, less than 75 parts of said one or more polyoxyalkylene polyols which have an oxyethylene unit content of at least 40 wt. %.

10. A flexible polyurethane foam prepared by a process according to claim 1.

11. A flexible polyurethane foam according to claim 10 characterised in that said organogel material is incorporated in the foam to form at least part of the cell ribs, the organogel material forming in particular inclusions in said cell ribs.

12. A flexible polyurethane foam according to claim 10 characterised in that said organogel material is incorporated in the foam to form at least part of the cell ribs and/or cell walls, the organogel material forming in particular inclusions in said cell ribs and/or cell walls.

13. A flexible polyurethane foam according to claim 10, characterised in that the reaction mixture comprises such an amount of said blowing agent that the prepared polyurethane foam has a density of between 25 and 120 kg/m³, the density of the prepared polyurethane foam being preferably lower than 100 kg/m³ and more preferably lower than 80 kg/m³.

14. A flexible polyurethane foam according to claim 10, characterised in that the prepared polyurethane foam has a resilience, measured at 20° C. in accordance with ASTM D 3574 H, higher than 35% and preferably higher than 45%.

15. A flexible polyurethane foam according to claim 10, characterised in that the prepared polyurethane foam has an ILD 40% hardness, measured in accordance with ISO 2439 B, between 60 and 500 N, and preferably between 75 and 200 N.
